(19) United States
(12) Patent Application Publication
(10) Pub. No.: US 2014/0288678 A1
(43) Pub. Date: Sep. 25, 2014

(54) ELECTRICAL APPLIANCE CONTROL APPARATUS, ELECTRICAL APPLIANCE CONTROL METHOD, ELECTRICAL APPLIANCE CONTROL SYSTEM, INPUT DEVICE, AND ELECTRICAL APPLIANCE

(71) Applicant: SHARP KABUSHIKI KAISHA, Osaka (JP)

(72) Inventors: Hideaki KIZUKI, Osaka-shi (JP); Toru UEDA, Osaka-shi (JP)

(73) Assignee: SHARP KABUSHIKI KAISHA, Osaka (JP)

(21) Appl. No.: 14/210,849

(22) Filed: Mar. 14, 2014

(30) Foreign Application Priority Data
Mar. 19, 2013 (JP) 2013-057323

(51) Int. Cl. G05B 15/02

(52) U.S. Cl. CPC G05B 15/02
USPC 700/83

(57) ABSTRACT

A control server includes: a determining section for analyzing a user's input to an cleaning robot, and for determining a state of the user; and a control section for deciding, with reference to a result of the determination made by the determining section, an electrical appliance to be controlled and a content of the control, and for controlling, with reference to a content of the decision made by the control section, the electrical appliance to be controlled.

This Nonprovisional application claims priority under 35 U.S.C. §119(a) on Patent Application No. 2013-057323 filed in Japan on Mar. 19, 2013, the entire contents of which are hereby incorporated by reference.

### TECHNICAL FIELD

The present invention relates to an electrical appliance control apparatus, an electrical appliance control method, an electrical appliance control system, an input device, and an electrical appliance.

### BACKGROUND ART

Domestic electrical appliances have recently become so widely used that people are surrounded by a wide variety of domestic electrical appliances in their lives. Under present circumstances, operation of these domestic electrical appliances are totally left to users. For example, turning on/off a television, changing the temperature of an air-conditioning apparatus, etc. are achieved by users' operating the domestic electrical appliances with remote controllers, etc., respectively.

For those elderly people who are unaccustomed to operating domestic electrical appliances and those people who have difficulties moving their bodies, it is not easy to operate domestic electrical appliances by themselves. Some devices for making it easier to operate domestic electrical appliances have recently been made. For example, Patent Literature 1 discloses an interactive operation-assisting system that uses, as a user interface, an animated personified character, called “assistant”, that produces reactions by speech synthesis or by animation. In the interactive operation-assisting system disclosed in Patent Literature 1, a user gives an instruction (e.g. an instruction to record a program) to the assistant by sound input or the like and an action corresponding to the instruction is performed.

### CITATION LIST

Patent Literature 1
Japanese Patent Application Publication, Tokukai, No. 2002-41276 (Publication Date: Feb. 8, 2002)

### SUMMARY OF INVENTION

### Technical Problem

However, even with use of the interactive operation-assisting system of Patent Literature 1, the user still has to input an operation instruction by him/herself to operate each domestic electrical appliance. Some users hesitate to input operation instructions by themselves to operate domestic electrical appliances, and other users just do not bother to do so. For such users, a system is desired that performs the operation of a domestic electrical appliance without a user's voluntarily giving an operation instruction to operate the domestic electrical appliance.

Further, for those users who are handicapped, it may be difficult to input operation instructions to operate domestic electrical appliances. For such users, too, a system is strongly desired that performs the operation of a domestic electrical appliance without a user's voluntarily giving an operation instruction to operate the domestic electrical appliance.

The present invention has been made in view of the foregoing problems, and it is an object of the present invention to provide an electrical appliance control apparatus, an electrical appliance control method, an electrical appliance control system, an input device, and an electrical appliance for controlling an electrical appliance in consideration of the state of a user without the user's voluntarily inputting an operation instruction to operate the electrical appliance.

Additional objects, features, and strengths of the present invention will be made clear by the description below. Further, the advantages of the present invention will be evident from the following explanation in reference to the drawings.

### Solution to Problem

In order to solve the foregoing problems, an electrical appliance control apparatus according to an aspect of the present invention includes: determining means for analyzing a user's input to an input device, and for determining a state of the user; deciding means for deciding, with reference to a result of the determination made by the determining means, an electrical appliance to be controlled and a content of the control; and control means for controlling, with reference to a content of the decision made by the deciding means, the electrical appliance to be controlled.

Further, in order to solve the foregoing problems, an electrical appliance control method according to an aspect of the present invention includes: a determining step of analyzing a user's input to an input device, and of determining a state of the user; a deciding step of deciding, with reference to a result of the determination made in the determining step, an electrical appliance to be controlled and a content of the control; and a control step of controlling, with reference to a content of the decision made in the deciding step, the electrical appliance to be controlled.

Further, in order to solve the foregoing problems, an electrical appliance control system according to an aspect of the present invention includes: an electrical appliance control apparatus including: determining means for analyzing a user's input to an input device, and for determining a state of the user; deciding means for deciding, with reference to a result of the determination made by the determining means, an electrical appliance to be controlled and a content of the control; and control means for controlling, with reference to a content of the decision made by the deciding means, the electrical appliance to be controlled; and the input device.

Further, in order to solve the foregoing problems, an electrical appliance control system according to an aspect of the present invention is an electrical appliance control system including: an input device for receiving input from a user; an electrical appliance control apparatus for controlling an electrical appliance; and the electrical appliance, which is to be controlled by the electrical appliance control apparatus, the electrical appliance control apparatus including: determining means for analyzing a user's input to an input device, and for determining a state of the user; deciding means for deciding, with reference to a result of the determination made by the determining means, an electrical appliance to be controlled and a content of the control; and control means for controlling, with reference to a content of the decision made by the deciding means, the electrical appliance to be controlled.

Further, in order to solve the foregoing problems, an input device according to an aspect of the present invention includes: input receiving means for receiving input from a user; and transmitting means for transmitting, to an electrical appliance control apparatus, input information which indicates the input received by the input receiving means and which is referred to for determining a state of the user and for deciding, with reference to a result of the determination of the state of the user, an electrical appliance to be controlled and a content of the control.

Further, in order to solve the foregoing problems, an electrical appliance according to an aspect of the present invention includes: an instruction receiving means for receiving an operation instruction referring to a content of control of an electrical appliance as decided by an electrical appliance control apparatus analyzing a user's input to the input device, determining a state of the user, and referring to a result of the determination of the state of the user, the electrical appliance controlling its operation in accordance with the operation instruction received by the instruction receiving means.

### Advantageous Effects of Invention

An electrical appliance control apparatus according to the present invention makes it possible to determine the state of a user by input from the user, and makes it possible, without forcing the user to perform a complex operation, to control an electrical appliance with reference to a result of the determination. This makes it possible to make the user less hesitate or bother to control an electrical appliance.

### BRIEF DESCRIPTION OF DRAWINGS

FIG. 1 is a block diagram showing a configuration of a main part of a control server in an electrical appliance control system according to an embodiment of the present invention.

FIG. 2 is a diagram showing an overview of an electrical appliance control system according to an embodiment of the present invention.

FIG. 3 is a diagram showing a table that is used in an electrical appliance control system according to an embodiment of the present invention.

FIG. 4 is a diagram showing a table that is used in an electrical appliance control system according to an embodiment of the present invention.

FIG. 5 is a flow chart showing the flow of a process of controlling an electrical appliance in an embodiment of the present invention.

FIG. 6 is a diagram showing a table that is used in an electrical appliance control system according to another embodiment of the present invention.

FIG. 7 is a diagram showing a table that is used in an electrical appliance control system according to another embodiment of the present invention.

FIG. 8 is a diagram showing a table that is used in an electrical appliance control system according to another embodiment of the present invention.

FIG. 9 is a flow chart showing the flow of a process of controlling an electrical appliance in another embodiment of the present invention.

FIG. 10 is a diagram showing a table that is used in an electrical appliance control system according to still another embodiment of the present invention.

FIG. 11 is a diagram showing a table that is used in an electrical appliance control system according to still another embodiment of the present invention.

FIG. 12 is a flow chart showing the flow of a process of controlling an electrical appliance in still another embodiment of the present invention.

FIG. 13 is a block diagram showing a configuration of a main part of an input device according to an embodiment of the present invention.

FIG. 14 is a block diagram showing a configuration of a main part of an electrical appliance according to an embodiment of the present invention.

### DESCRIPTION OF EMBODIMENTS

Some embodiments of the present invention are described in detail with reference to the drawings. In the description of the embodiments below, components identical in function and working are assigned the same reference signs, and as such, are not repeatedly described.

In each of the embodiments described below, an electrical appliance control apparatus of the present invention is described by taking, as an example, a case where it is applied to an electrical appliance control system. The electrical appliance control system is a system that controls an electrical appliance, particularly a domestic electrical appliance, in consideration of the state of a user. The electrical appliance control apparatus of the present invention is achieved as a control server in the electrical appliance control system. The control server analyzes input that a user inputted to an input/output device, determines a state of the user, and controls an electrical appliance in accordance with a result of the determination. The electrical appliance control system will be described in detail later.

### First Embodiment

### Overview of an Electrical Appliance Control System

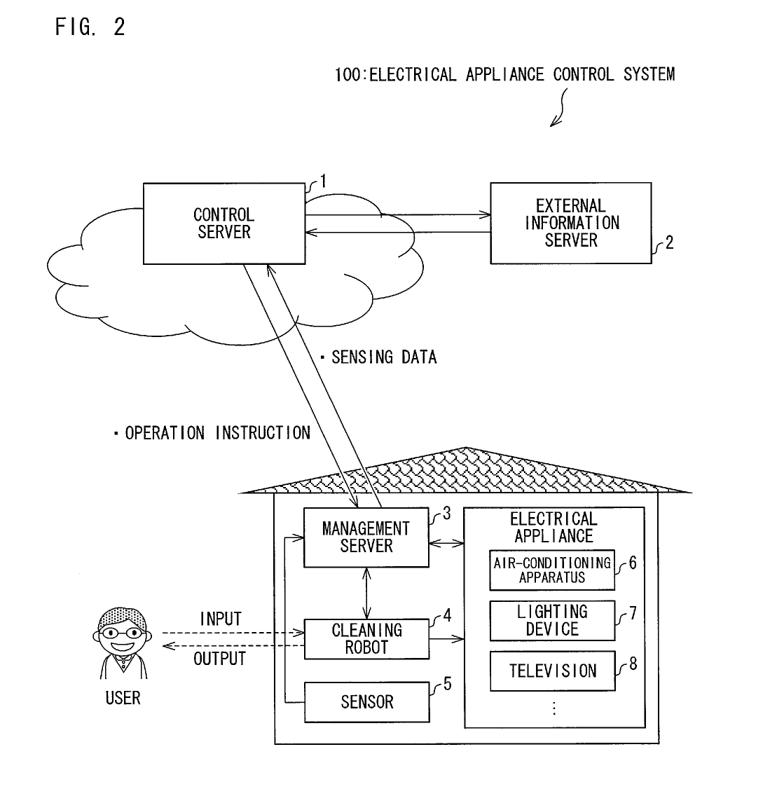

A first embodiment of the present invention is described with reference to FIG. 2. FIG. 2 is a diagram showing an overview of an electrical appliance control system 100.

The electrical appliance control system 100 is a system that controls an electrical appliance, particularly a domestic electrical appliance, in consideration of the state of a user. As shown in FIG. 2, the electrical appliance control system 100 includes a control server 1 as an electrical appliance control apparatus, an external information server 2, a management server 3, and a cleaning robot 4 as an input/output device. The management server 3 is in wireless communication connection with the cleaning robot 4, and is also in wire or wireless communication connection with other electrical appliances. FIG. 2 shows an example where the electrical appliances are an air-conditioning apparatus 6, a lighting device 7, and a television 8. However, the electrical appliances are not particularly limited in type or in number.

The control server 1 analyzes input that the user inputted to the cleaning robot 4, determines the state of the user, and controls an electrical appliance in accordance with a result of the determination. More specifically, the control server 1 determines the state of the user by analyzing input that the user inputted to the cleaning robot 4, and transmits to the management server 3 an operation instruction corresponding to a result of the determination, thereby controlling the operation of the cleaning robot 4 or a domestic electrical appliance.

The management server 3 has overall control of exchange of information between the cleaning robot 4 or a domestic electrical appliance and the control server 1. Specifically, the management server 3 transmits to the control server 1 input information that the user inputted to the cleaning robot 4 and sensor information generated by a sensor placed in the home. Further, the management server 3 controls the operation of the cleaning robot 4 or a domestic electrical appliance in accordance with an operation instruction received from the control server 1. The external information server 2 is an external server such as an Internet server, and obtains various types of information from external sources.

In a case where there is no need for overall control, the electrical appliance control system may be configured such that without the management server 3 being provided, the cleaning robot 4 exchanges information with the control server 1. Alternatively, the cleaning robot 4 may function as the control server 1 and the management server 3. Further, although the example shown in FIG. 2 looks as if the management server 3 were installed in the home, the electrical appliance control system may be configured such that the management server 3 is outside of the home or in the control server 1.

The cleaning robot 4 is a self-propelled cleaner that automatically cleans floors. Further, in addition to the cleaning function, the cleaning robot 4 also functions as an input/output device having an input/output function of receiving sound input or the like and producing sound output or the like. The cleaning robot 4 receives sound input or the like produced by the user. Further, the cleaning robot 4 also sends sound output or the like to the user. It should be noted that the input to and output from the cleaning robot 4 are not to be limited to sound. For example, the input to and output from the cleaning robot 4 may be text, pictures, etc. or a combination thereof.

The air-conditioning apparatus 6 is an apparatus that performs air conditioning such as cooling and heating, and is a so-called air conditioner. Further, the air-conditioning apparatus 6 includes a temperature sensor, and transmits to the management server 3 information on a temperature in the room as detected by the temperature sensor. The lighting device 7 is a lighting device including a light source such as an LED, and can be turned on and off under the control of the management server 3. Further, the television 8 is a television receiver, and the television 8, too, can be turned on and off under the control of the management server 3. It should be noted that the sensor 5, placed in the home, may be mounted on the cleaning robot 4 or on a domestic electrical appliance, or may be independently placed in the home.

(Configuration of the Control Server 1)

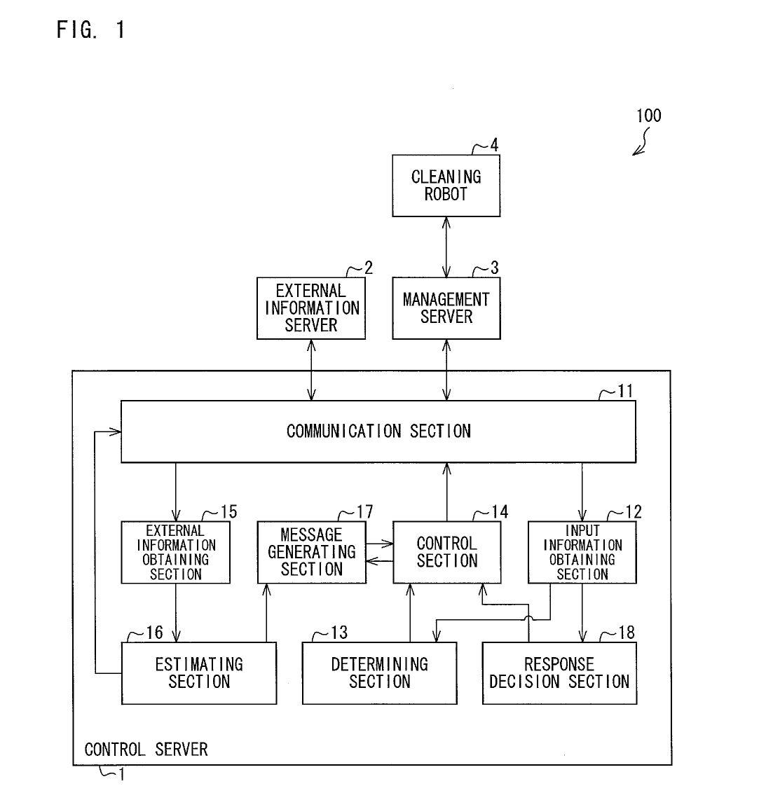

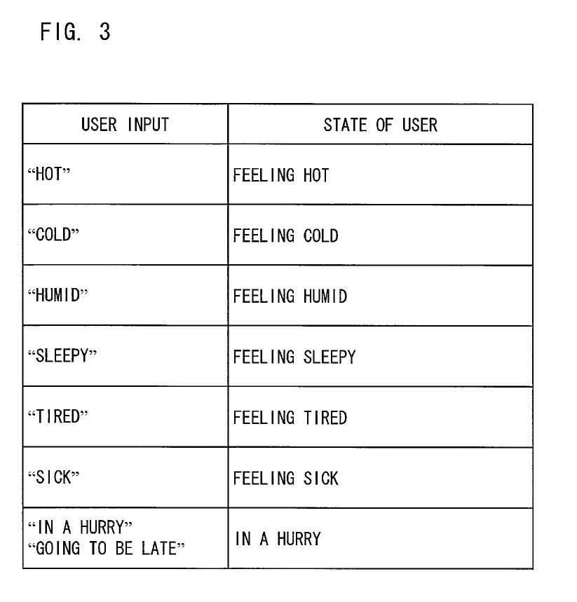

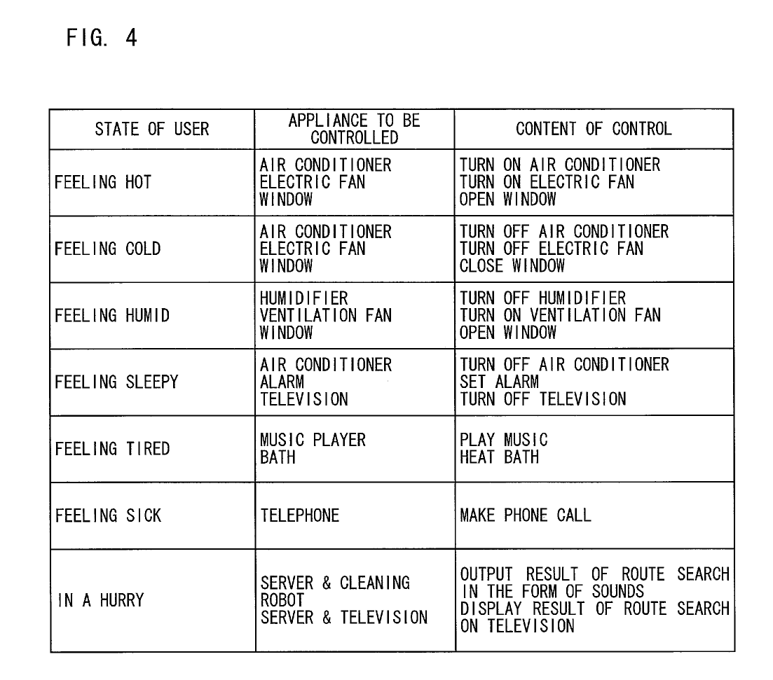

A configuration of the control server 1 of the electrical appliance control system 100 is described in detail with reference to FIGS. 1, 3, and 4. FIG. 1 is a block diagram showing a configuration of a main part of the control server 1 in the electrical appliance control system 100. FIGS. 3 and 4 are each a diagram showing a table that is used in the electrical appliance control system 100.

As shown in FIG. 1, the control server 1 includes a communication section 11, an input information obtaining section 12, a determining section 13, a control section 14, an external information obtaining section 15, an estimating section 16, and a message generating section 17. The communication section 11 is a component for communicating externally, and communicates with the external information server 2 and the management server 3 via a network.

The input information obtaining section 12 obtains, from the management server 3 via the communication section 11, input information that the user inputted to the cleaning robot 4. Examples of the input information include sound data, text data, video data, etc. that are obtained by the user's making sounds, inputting text, or making motions (gestures).

The determining section 13 analyzes the input information obtained by the input information obtaining section 12 and determines the state of the user. The determining section 13 makes such a determination with reference to a first table. The first table is a table, stored in the determining section 13, which shows correspondence between input information that the user inputted to the cleaning robot 4 and a result of a determination in response to the input information. An example of the first table is shown in FIG. 3. The first table shown in FIG. 3 shows correspondence between a word(s) contained in an utterance produced by the user and a result of a determination in response to the word(s). It should be noted that the first table stored in the determining section 13 is not to be limited to the first table shown in FIG. 3.

With reference to a result of the determination made by the determining section 13, the control section 14 decides an electrical appliance to be controlled and a content of the control. The control section 14 makes such a decision with reference to a second table. The second table is a table, stored in the control section 14, which shows correspondence between a result of a determination made by the determining section 13 and a corresponding combination of an appliance(s) to be controlled and a content(s) of the control. FIG. 4 shows an example of the second table. It should be noted that the second table stored in the control section 14 is not to be limited to the second table shown in FIG. 4.

With reference to the content of its decision, the control section 14 controls, in accordance with a given content of control, the electrical appliance to be controlled. Specifically, the control section 14 refers to the content of its decision and transmits, to the management server 3 via the communication section 11, an operation instruction to operate the electrical appliance to be controlled. In accordance with the operation instruction received from the control server 1, the management server 3 controls the operation of the electrical appliance to be controlled.

The external information obtaining section 15, the estimating section 16, and the message generating section 17 will be described in detail later. It should be noted that the present embodiment does not necessarily have to have these components, and can omit to have these components.

(Control of an Electrical Appliance)

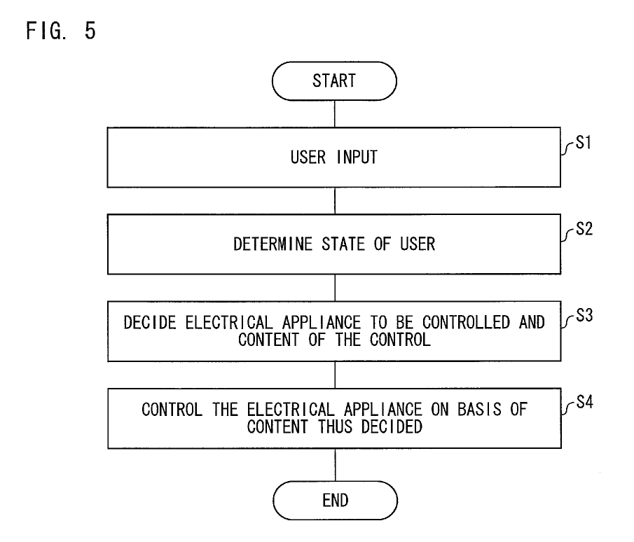

A method for controlling an electrical appliance in the present embodiment is described below with reference to FIG. 5. FIG. 5 is a flow chart showing the flow of a process of controlling an electrical appliance in the present embodiment.

First, input by the user is done (step 1; hereinafter abbreviated as S1). The term “input by the user” here means the user's making sounds, the user's inputting text, or the user's making motions (gestures). The cleaning robot 4 sends to the management server 3 information (such as sound data, text data, video data) inputted by the user.

The input information obtaining section 12 obtains, from the management server 3 via the communication section 11, the input information that the user inputted to the cleaning robot 4. The determining section 13 analyzes the input information obtained by the input information obtaining section 12 and determines the state of the user (S2). Specifically, the determining section 13 derives, with reference to the first table, a result of a determination corresponding to the input that the user inputted to the cleaning robot 4. For example, see a case where the first table shown in FIG. 3 is used. In this case, when the word “hot” is contained in an utterance produced by the user, the determining section 13 determines that the user is currently in such a state that he/she is “feeling hot”. The determining section 13 sends a result of the determination to the control section 14.

With reference to the result of the determination made by the determining section 13, the control section 14 decides an electrical appliance to be controlled and a content of the control (S3). Specifically, with reference to the second table, the control section 14 decides, in consideration of the state of the user, an electrical appliance to be controlled and a content of the control. For example, see a case where the second table shown in FIG. 4 is used. In this case, when the determining section 13 has determined that the user is currently in such a state that he/she is “feeling hot”, the candidate electrical appliances to be controlled are “AIR CONDITIONER”, “ELECTRIC FAN”, and “WINDOW”. In such a case where there are a plurality of candidate electrical appliances to be controlled, one option is to control the plurality of electrical appliances all at once, or anther option is to determine the priority for the electrical appliances and choose the electrical appliance given first priority as electrical appliance to be controlled. The priority can be determined by any method, e.g. by the user's determining the priority or determining the priority in the order of frequency of use. Let it be assumed, in a case where the second table shown in FIG. 4 is used, that the air conditioner is given first priority. Then, the control section 14 chooses “AIR CONDITIONER” as electrical appliance to be controlled and chooses “TURN ON AIR CONDITIONER” as content of the control.

With reference to the content of its decision, the control section 14 controls, in accordance with a given content of control, the electrical appliance to be controlled (S4). Specifically, the control section 14 refers to the content of its decision and transmits, to the management server 3 via the communication section 11, an operation instruction to operate the electrical appliance to be controlled. In accordance with the operation instruction received from the control server 1, the management server 3 controls the operation of the electrical appliance to be controlled.

Thus described is a series of actions that are done to control an electrical appliance in the electrical appliance control system 100. Since information produced by the user's saying how he/she is feeling (such as “hot” or “sleepy”) is inputted to the cleaning robot 4, the control server 1 analyzes the information inputted to the cleaning robot 4 and determines the state of the user. Then, with reference to a result of the determination, the control server 1 controls the electrical appliance. Therefore, in the electrical appliance control system 100, the control server 1 voluntarily controls an electrical appliance in consideration of the state of the user even without the user's voluntarily inputting an operation instruction to control the electrical appliance.

Some users hesitate to input operation instructions by themselves to operate electrical appliances, and other users just do not bother to do so. Further, for those users who are handicapped, it may be difficult to input operation instructions to operate domestic electrical appliances. However, the electrical appliance control system 100 according to the present embodiment makes it only necessary for a user to, for example, say how he/she is feeling, and makes it unnecessary for the user to input an operation instruction by him/herself to operate each electrical appliance. This makes it possible, without forcing the user to perform a complex operation, to control an electrical appliance. Therefore, the electrical appliance control system 100 according to the present embodiment is most suitable to such users as those mentioned above.

(Example 1 of Electrical Appliance Control)

Here is a specific example of a method in which the electrical appliance control system 100 controls an electrical appliance. The example below is merely an example, and the electrical appliance control system 100 according to the present embodiment is not to be limited solely to the example below.

Control of an electrical appliance by the electrical appliance control system 100 in a case where the user is feeling cold is described. It should be noted that it is assumed that the cleaning robot 4 includes an input/output function of receiving sound input and producing sound output.

When the user says “cold”, the sound “cold” made by the user is inputted to the cleaning robot 4. The cleaning robot 4 sends to the management server 3 the sound data thus inputted. The input information obtaining section 12 obtains, from the management server 3 via the communication section 11, the input information that the user inputted to the cleaning robot 4. The determining section 13 derives, with reference to the first table, a result of a determination corresponding to the input that the user inputted to the cleaning robot 4. For example, see a case where the first table shown in FIG. 3 is used. In this case, when the word “cold” is contained in an utterance produced by the user, the determining section 13 determines that the user is currently in such a state that he/she is “feeling cold”. The determining section 13 sends a result of the determination to the control section 14.

With reference to the second table, the control section 14 decides, in consideration of the state of the user, an electrical appliance to be controlled and a content of the control. For example, see a case where the second table shown in FIG. 4 is used. In this case, since the determining section 13 has determined that the user is currently in such a state that he/she is “feeling cold”, the candidate electrical appliances to be controlled are “AIR CONDITIONER”, “ELECTRIC FAN”, and “WINDOW”. See a case where there are a plurality of candidate electrical appliances to be controlled and where the priority is determined for the electrical appliances and the electrical appliance given first priority is chosen as electrical appliance to be controlled. In this case, if the air conditioner is given first priority, then the control section 14 chooses “AIR CONDITIONER” as electrical appliance to be controlled and chooses “TURN OFF AIR CONDITIONER” as content of the control.

With reference to the content of its decision, the control section 14 transmits, to the management server 3 via the communication section 11, an instruction to turn off the air conditioner. In accordance with the operation instruction received from the control server 1, the management section 3 controls the air conditioner so that the air conditioner is turned off.

The contents of control in the second table shown in FIG. 4 are based on the premise that the season is summer, but are not to be so limited. For example, in wintertime, the “state in which the user is feeling cold” may be associated with the content of control “TURN ON HEATER”.

### Second Embodiment

A second embodiment of the present invention is described.

In the present embodiment, the control server 1 estimates the state of the user with reference to external information obtained from an external source, and asks the user about his/her state with reference to a result of the estimation. The control server 1 analyzes a reply from the user, determines the state of the user, and controls an electrical appliance in consideration of a result of the determination. More specifically, the control server 1 estimates the state of the user with reference to external information obtained from an external source and, with reference to a result of the estimation, causes the cleaning robot 4 to output a question asking the user about his/her state. The control server 1 analyzes a reply that the user inputted to the cleaning robot 4, determines the state of the user, and transmits an operation instruction corresponding to a result of the determination to the management server 3, thereby controlling the operation of the cleaning robot 4 or a domestic electrical appliance.

(Configuration of the Control Server 1)

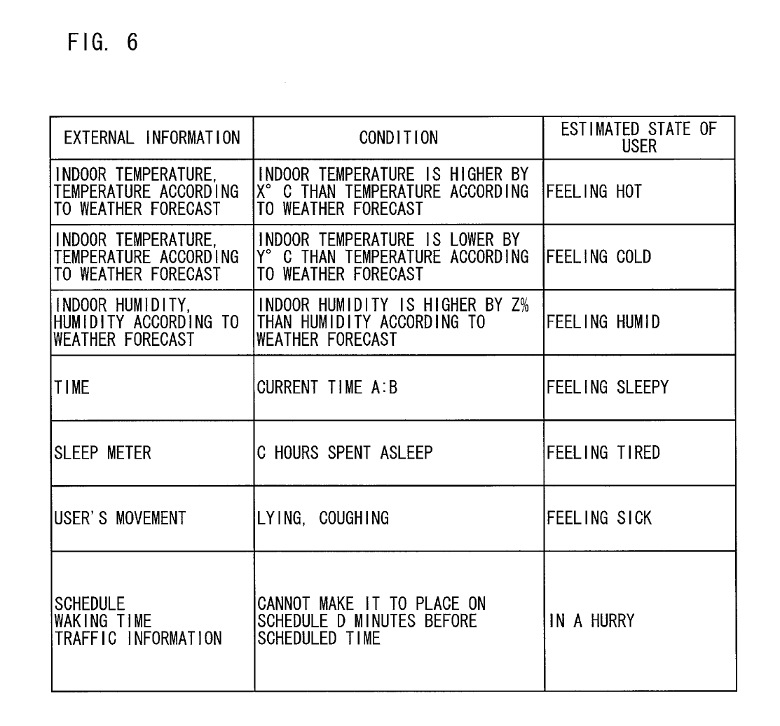

Prior to a detailed description of a control method, a configuration of components that contribute to control is described in detail with reference to FIGS. 6 through 8. FIGS. 6 through 8 are each a diagram showing a table that is used in the electrical appliance control system 100.

As mentioned above, the control server 1 further includes an external information obtaining section 15, an estimating section 16, and a message generating section 17.

The external information obtaining section 15 obtains external information from the external information server 2 or from the management server 3 via the communication section 11. For example, the external information obtaining section 15 obtains weather forecast information, traffic information, etc. as external information from the external information server and obtains as external information from the management server 3 sensor information (such as indoor temperature information, indoor humidity information) generated by the sensor 5 placed in the home. The external information obtaining section 15 can obtain, as external information, information such as schedules that members recorded in the external information server 2.

The estimating section 16 estimates the state of the user with reference to the external information obtained by the external information obtaining section 15. Specifically, the estimating section 16 determines whether or not the external information obtained by the external information obtaining section 15 satisfies a predetermined condition. In a case where the external information satisfies the predetermined condition, the estimating section 16 derives, as an estimated current state of the user, a state of the user as associated with the predetermined condition. The estimating section 16 makes such an estimation with reference to a third table. The third table is a table, stored in the estimating section 16, which shows correspondence among external information obtained by the external information obtaining section 15, a preset condition, and a result of an estimation associated with the preset condition (a state of the user as estimated from the external information). An example of the third table is shown in FIG. 6. It should be noted that the third table stored in the estimating section 16 is not to be limited to the third table shown in FIG. 6.

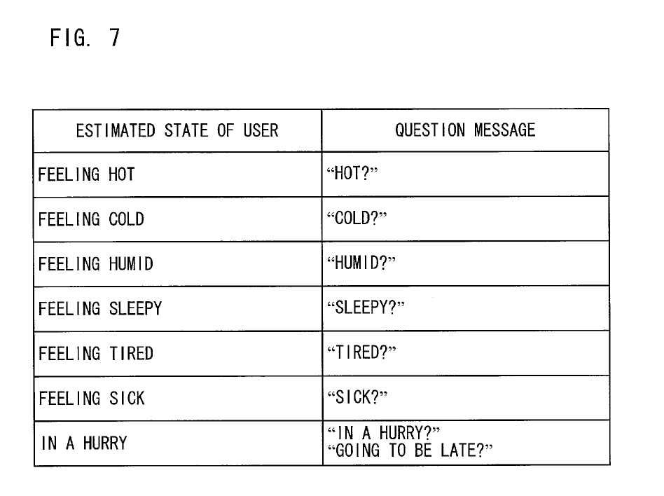

The message generating section 17 generates, with reference to a result of the estimation made by the estimating section 16, a question message asking the user about his/her state. Specifically, the message generating section 17 has stored therein a fourth table showing correspondence between a result of an estimation by the estimating section 16 and a question message corresponding to the result of the estimation. An example of the fourth table is shown in FIG. 7. The message generating section 17 generates, with reference to the fourth table, a question message corresponding to an estimated state of the user. It should be noted that the fourth table stored in the message generating section 17 is not to be limited to the fourth table shown in FIG. 7.

The control section 14 causes the cleaning robot 4 to output the question message generated by the message generating section 17. Specifically, the control section 14 transmits, to the management server 3 via the communication section 11, an operation instruction to output the question message generated by the message generating section 17. In accordance with the operation instruction received from the control server 1, the management server 3 causes the cleaning robot 4 to output the question message. The question message may be outputted in any form, e.g. in the form of sounds or text.

In this case, the user makes a reply to the question message. The cleaning robot 4 receives as input the sounds, text, motions, etc. that the user made in reply. The input information obtaining section 12 obtains, from the management server 3 via the communication section 11, the input information that the user inputted to the cleaning robot 4.

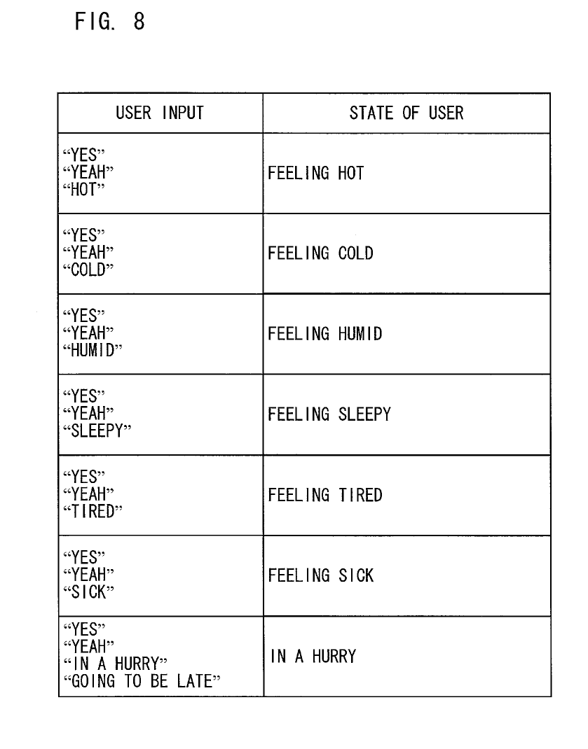

The determining section 13 analyzes the input information obtained by the input information obtaining section 12 and determines the state of the user. In the present embodiment, since the cleaning robot 4 receives a reply to a question message, the cleaning robot 4 also receives input such as “yes” or “no” meaning affirmation or negation. For this purpose, the determining section 13 has stored therein a fifth table showing correspondence between input information including input meaning affirmation and negation as inputted to the cleaning robot 4 and a result of a determination corresponding to the input information (a state of the user as derived from the input information). An example of the fifth table is shown in FIG. 8. The fifth table shown in FIG. 8 shows correspondence between a word(s) contained in utterances produced by the user and a result of a determination corresponding to the word(s). The determining section 13 derive, with reference to the fifth table, a result of a determination corresponding to a reply that the user inputted to the cleaning robot 4. It should be noted that the fifth table stored in the determining section 13 is not to be limited to the fifth table shown in FIG. 8.

With reference to the result of the determination made by the determining section 13, the control section 14 decides an electrical appliance to be controlled and a content of the control. With reference to the content of its decision, the control section 14 controls, in accordance with a given content of control, the electrical appliance to be controlled. The control section 14 is identical in detailed configuration to that of the first embodiment.

Although the first embodiment was described by taking as an example a method including the steps of: in a case where there are a plurality of candidate electrical appliances to be controlled, determining the priority for the electrical appliances; and choosing the electrical appliance given first priority as electrical appliance to be controlled, this does not necessarily imply an limitation. For example, the present embodiment may be configured to, in a case where the difference between the indoor temperature and temperature according to the weather forecast is smaller than a predetermined temperature difference, choose the electric fan as electrical appliance to be controlled and to, in a case where the difference is not smaller than the predetermined temperature difference, choose the air conditioner as electrical appliance to be controlled. In this way, an electrical appliance to be controlled may be chosen in accordance with external information obtained by the external information obtaining section 15.

(Control of an Electrical Appliance)

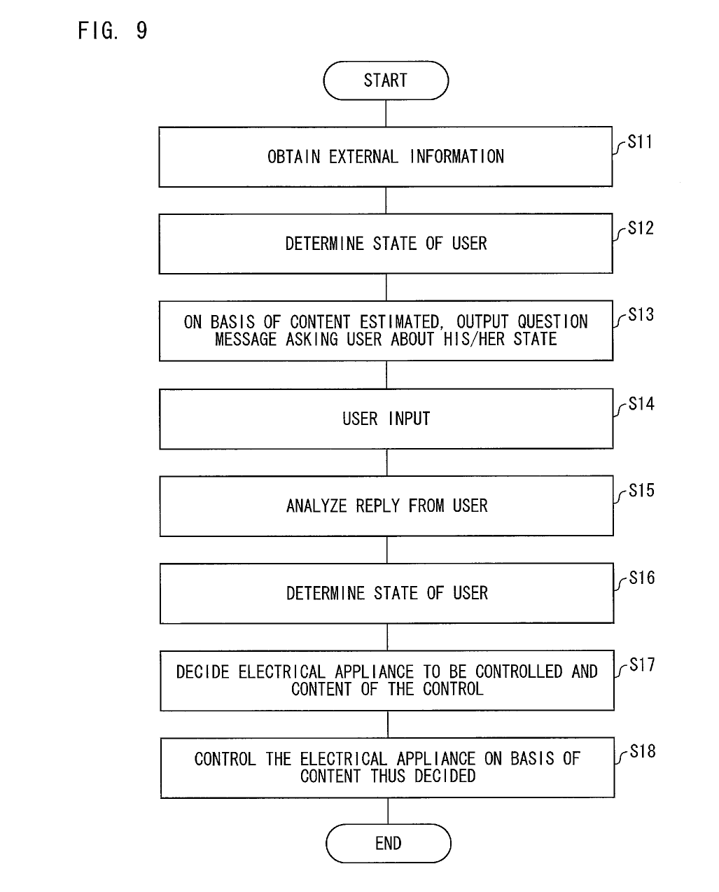

A method for controlling an electrical appliance in the present embodiment is described below with reference to FIG. 9. FIG. 9 is a flow chart showing the flow of a process of controlling an electrical appliance in the present embodiment.

First, the external information obtaining section 15 obtains external information (S11). Then, the estimating section 16 estimates a state of the user with reference to the external information obtained by the external information obtaining section 15 (S12). Specifically, the estimating section 16 determines, with reference to the third table, whether or not the external information obtained by the external information obtaining section 15 satisfies a predetermined condition. For example, see a case where the third table shown in FIG. 6 is used. In this case, when the external information obtaining section 15 obtains information on the indoor temperature and information on the temperature according to the weather forecast, the estimating section 16 determines whether the indoor temperature is higher by X° C. or lower by Y° C. than the temperature according to the weather forecast. If the indoor temperature is higher by X° C. than the temperature according to the weather forecast, the estimation section 16 estimates that the user is in such a state that he/she is “feeling hot”. On the other hand, if the indoor temperature is lower by Y° C. than the temperature according to the weather forecast, the estimation section 16 estimates that the user is in such a state that he/she is “feeling cold”. The estimating section 16 sends a result of the estimation to the message generating section 17.

With reference to the result of the estimation made by the estimating section 16, the message generating section 17 generates a question message asking the user about his/her state. Specifically, the message generation section 17 generates, with reference to the fourth table, a question message corresponding to the estimated state of the user. For example, see a case where the fourth table shown in FIG. 7 is used. In this case, when the estimating section 16 estimates that the user in currently in such a state that he/she is “feeling hot”, the message generating section 17 generates a question message “Are you feeling hot?”. The message generating section 17 sends the question message thus generated to the control section 14, and the control section 14 causes the cleaning robot 4 to output the question message generated by the message generating section 17 (S13). Specifically, the control section 14 transmits, to the management server 3 via the communication section 11, an operation instruction to output the question message generated by the message generating section 17. In accordance with the operation instruction received from the control server 1, the management server 3 causes the cleaning robot 4 to output the question message.

After that, input by the user is done (S14). Specifically, the user inputs a reply to the question message outputted by the cleaning robot 4. Then, the input information obtaining section 12 obtains, from the management server 3 via the communication section 11, the input information that the user inputted to the cleaning robot 4.

The determining section 13 analyzes the input information obtained by the input information obtaining section 12 (S15), and determines the state of the user (S16). Specifically, the determining section 13 derives, with reference to the fifth table, a result of a determination corresponding to the reply that the user inputted to the cleaning robot 4. For example, see a case where the fifth table shown in FIG. 8 is used. In this case, when a word “yeah” is contained in an utterance produced by the user, the determining section 13 determines that the user is currently in such a state that he/she is “feeling hot”. The determining section 13 sends the result of the determination to the control section 14.

The subsequent steps (S17 and S18) are the same as steps S3 and S4 of FIG. 5, and as such, are not described here.

Thus described is a series of actions that are done to control an electrical appliance in the electrical appliance control system 100. In this way, the control server 1 estimates a state of a user with reference to external information. Then, with reference to a result of the estimation, the control server 1 causes the cleaning robot 4 to output a question message asking the user about his/her state. This makes it possible to, before the user tells how he/she is feeling (such as “hot” or “sleepy”), estimate the state of the user and cause the cleaning robot 4 to ask the user about his/her state. Such a question from the cleaning robot 4 encourages the user to tell the cleaning robot 4 about his/her state with less hesitation. In particular, in order for the control server 1 to voluntarily control an electrical appliance, the user needs only make a reply such as “yeah” or “yes” meaning affirmation to a question message outputted by the cleaning robot 4. This makes it unnecessary for the user to control the electrical appliance by him/herself, and is very simple for the user.

Although not illustrated in the fifth table shown in FIG. 8, in a case where the user has made a reply meaning negation such as “uh-uh” or “no” to a question message outputted by the cleaning robot 4, the control server 1 does not need to control any of the electrical appliances. Further, the user may make a reply telling a state that is different from the state of the user as estimated by the estimating section 16. For example, the user may make a reply “cold” to a question message “Are you feeling hot?” outputted by the cleaning robot 4. In this case, the determining section 13 analyzes the user's reply and determines that the user is in such a state that he/she is “feeling cold”, and the control section 14 needs only execute a process that is to be executed when the user is in such a state that he/she is “feeling cold”.

(Example 2 of Electrical Appliance Control)

Here is a second specific example of a method in which the electrical appliance control system 100 controls an electrical appliance. The example below is merely an example, and the electrical appliance control system 100 according to the present embodiment is not to be limited solely to the example below.

Control of an electrical appliance by the electrical appliance control system 100 in a case where the user is in a hurry is described. It should be noted that it is assumed that the cleaning robot 4 includes an input/output function of receiving sound input and producing sound output.

The estimating section 16 determines, with reference to the third table, whether or not external information obtained by the external information obtaining section 15 satisfies a predetermined condition. For example, see a case where the third table shown in FIG. 6 is used. In this case, when the external information obtaining section 15 obtains the user's waking time, the user's schedule, and the current traffic information, the estimating section 16 determines, with reference to the waking time as a time of departure, whether or not the user can make it to the place on the schedule D minutes before the scheduled time. If the result of the determination indicates that the user cannot make it, the estimating section 16 estimates that the user is in such a state that he/she is in a hurry. The estimating section 16 sends a result of the estimation to the message generating section 17.

The message generating section 17 generates, with reference to the fourth table, a question message corresponding to the estimated state of the user. For example, see a case where the fourth table shown in FIG. 7 is used. In this case, since the estimating section 16 has estimated that the user is currently in such a state that he/she is “in a hurry”, the message generating section 17 generates a question message “Are you in a hurry?”. The message generating section 17 sends the question message thus generated to the control section 14, and the control section 14 causes the cleaning robot 4 to output the question message generated by the message generating section 17.

After that, when the user says “yes”, the cleaning robot 4 receives as input the sound “yes” produced by the user. The cleaning robot 4 sends the input sound data to the management server 3. The input information obtaining section 12 obtains, from the management server 3 via the communication section 11, the input information that the user inputted to the cleaning robot 4. The determining section 13 derives, with reference to the fifth table, a result of a determination corresponding to the user's input to the cleaning robot 4. For example, see a case where the fifth table shown in FIG. 8 is used. In this case, when a word “yes” is contained in an utterance produced by the user, the determining section 13 determines that the user is currently in such a state that he/she is “in a hurry”. The determining section 13 sends a result of the determination to the control section 14.

With reference to the second table, the control section 14 decides, in consideration of the state of the user, an electrical appliance to be controlled and a content of the control. For example, see a case where the second table shown in FIG. 4 is used. In this case, since the determining section 13 has determined that the user is currently in such a state that he/she is “in a hurry”, the candidate electrical appliances to be controlled are a combination of “SERVER” and “CLEANING ROBOT” and a combination of “SERVER” and “TELEVISION”. See a case where there are a plurality of candidate electrical appliances to be controlled and where the priority is determined for the electrical appliances and the electrical appliance given first priority is chosen as electrical appliance to be controlled. In this case, if the combination of “SERVER” and “TELEVISION” is given first priority, then the control section 14 chooses the combination of “SERVER” and “TELEVISION” as electrical appliances to be controlled and chooses “DISPLAY RESULT OF ROUTE SEARCH ON TELEVISION” as content of the control.

With reference to the content of its decision, the control section 14 obtains from the external information server 2 route information on the shortest route to the place on the schedule and transmits, to the management server 3 via the communication section 11, an instruction to display the route information on the television. In accordance with the operation instruction received from the control server 1, the management section 3 controls the television so that the television displays the route information.

It should be noted that the foregoing configuration is merely an example. Instead of displaying, on the display screen of a television, information obtained from the external information server 2, it is possible to display the information on the display screen of a smartphone or outputting the information in the form of sounds from the speaker of a television or a smartphone.

### Third Embodiment

A third embodiment of the present invention is described.

In the present embodiment, the control server 1 analyzes input that the user inputted to the cleaning robot 4, determines the state of the user, controls an electrical appliance in accordance with a result of the determination, and before actually controlling the electrical appliance, approaches the user with a proposal to control the electrical appliance. In response to a reply from the user, the control server 1 executes control based on the result of the determination. More specifically, the control server 1 decides, with reference to the result of the determination made by the determining section 13, an electrical appliance to be controlled and a content of the control, and then causes the cleaning robot 4 to output a proposal message putting forward a proposal to control the electrical appliance. In response to a reply that the user inputted to the cleaning robot 4, the control server 1 transmits to the management server 3 an operation instruction based on the content of the decision, thereby controlling the operation of the cleaning robot 4 or the electrical appliance.

(Configuration of the Control Server 1)

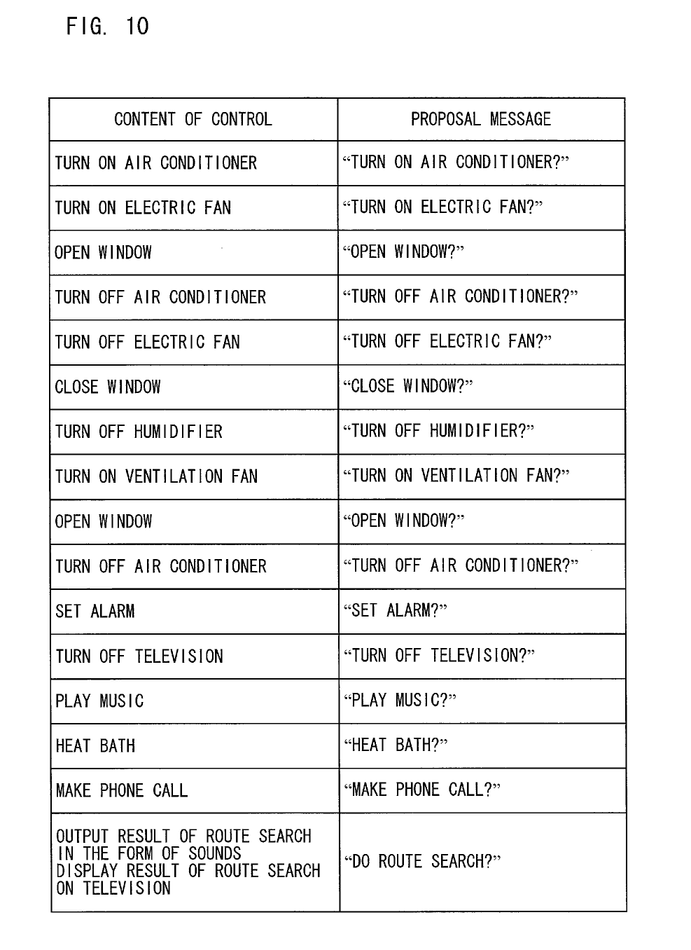

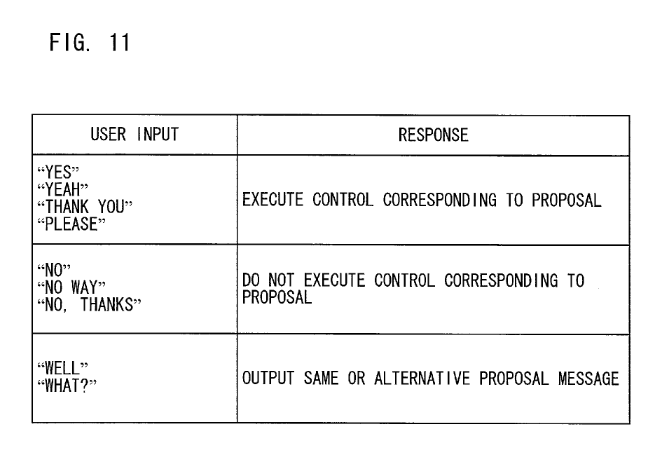

Prior to a detailed description of a control method, a configuration of components that contribute to control is described in detail with reference to FIGS. 10 and 11. FIGS. 10 and 11 are each a diagram showing a table that is used in the electrical appliance control system 100.

When the determining section 13 analyzes input information obtained by the input information obtaining section 12 and determines the state of the user, the control section 14 decides, with reference to a result of the determination made by the determining section 13, an electrical appliance to be controlled and a content of the control. With reference to a content of the decision made by the control section 14, the message generating section 17 generates a proposal message putting forward a proposal to control the electrical appliance. Specifically, the message generating section 17 has stored therein a sixth table showing correspondence between a content of control as decided by the control section 14 and a proposal message corresponding to the content of control. An example of the sixth table is shown in FIG. 10. The message generating section 17 generates, with reference to the sixth table, a proposal message corresponding to the state of the user. It should be noted that the sixth table stored in the message generating section 17 is not to be limited to the sixth table shown in FIG. 10.

The control section 14 causes the cleaning robot 4 to output the proposal message generated by the message generating section 17. Specifically, the control section 14 transmits, to the management server 3 via the communication section 11, an operation instruction to output the proposal message generated by the message generating section 17. In accordance with the operation instruction received from the control server 1, the management server 3 causes the cleaning robot 4 to output the proposal message. The proposal message may be outputted in any form, e.g. in the form of sounds or text.

In this case, the user makes a reply to the proposal message. The cleaning robot 4 receives as input the sounds, text, motions, etc. that the user made in reply. The input information obtaining section 12 obtains, from the management server 3 via the communication section 11, the input information that the user inputted to the cleaning robot 4.

The response decision section 18 analyzes the input information obtained by the input information obtaining section 12 and decides what response to make. In a case where the user's reply is a reply that agrees to the proposal, i.e., input that means consent such as “yes”, the response decision section 18 decides to execute control corresponding to the proposal. On the other hand, in a case where the user's reply is a reply that disagrees to the proposal, i.e., input that means dissent such as “no”, the response decision section 18 decides not to execute control corresponding to the proposal. Moreover, in a case where the user's reply neither agrees nor disagrees to the proposal, i.e., in a case where the user's reply is input that means neither consent nor dissent such as “What?”, the response decision section 18 decides to output the same or an alternative proposal message.

The response decision section 18 makes such a decision with reference to a seventh table. The seventh table is a table stored in the response decision section 18, and shows correspondence between input information inputted to the cleaning robot 4 and a response to be made corresponding to the input information. An example of the seventh table is shown in FIG. 11. The seventh table shown in FIG. 11 shows correspondence between a word(s) contained in an utterance produced by the user and a response to be made corresponding to the word(s). It should be noted that the seventh table stored in the response decision section 18 is not to be limited to the seventh table shown in FIG. 11.

In accordance with the content of the decision made by the response decision section 18, the control section 14 executes control based on the content of its decision. In a case where the response decision section 18 has decided, as the response to be made, to execute control corresponding to the proposal, the control section 14 refers to the content of its decision and controls, in accordance with a given content of control, the electrical appliance to be controlled. The control section 14 is identical in detailed configuration to that of the first embodiment. Further, in a case where the response decision section 18 has decided, as the response to be made, not to execute control corresponding to the proposal, the control section 14 does not execute control based on the content of its decision. Alternatively, in a case where the response decision section 18 has decided, as the response to be made, to output the same proposal message, the control section 14 transmits, to the management server 3 via the communication section 11, an operation instruction to output the same proposal message.

Alternatively, in a case where the response decision section 18 has decided, as the response to be made, to output an alternative proposal message, the control section 14 decides, with reference to the result of the determination made by the determining section 13, an alternative electrical appliance to be controlled and a content of the control. With reference to the content of the decision made by the control section 14, the message generating section 17 generates an alternative proposal message putting forward a proposal to control an alternative electrical appliance (for example, the electrical appliance given second priority, in a case where there are a plurality of candidate electrical appliances to be controlled). Then, the control section 14 transmits, to the management server 3 via the communication section 11, an operation instruction to output the alternative proposal message generated by the message generating section 17. In accordance with the operation instruction received from the control server 1, the management server 3 controls the operation of the electrical appliance to be controlled.

The first embodiment was described by taking as an example a method including the steps of: in a case where there are a plurality of candidate electrical appliances to be controlled, determining the priority for the electrical appliances in advance; and choosing the electrical appliance given first priority as electrical appliance to be controlled. In a case where this method is employed, for example, in the present embodiment, if the user's reply to the proposal message disagrees to the proposal, the priority of the electrical appliance proposed this time may be lowered next time.

(Control of an Electrical Appliance)

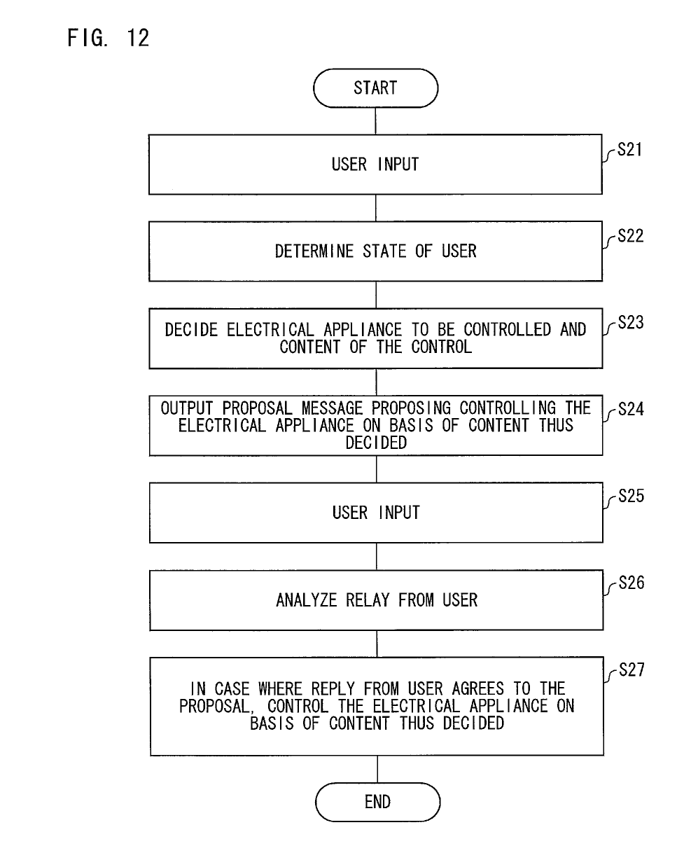

A method for controlling an electrical appliance in the present embodiment is described below with reference to FIG. 12. FIG. 12 is a flow chart showing the flow of a process of controlling an electrical appliance in the present embodiment.

Steps S21 to S23 are the same as steps S1 to S3 of FIG. 5, and as such, are not described here. The following starts by describing step S24 and its subsequent steps. First, in step S23, the control section 14 decides an electrical appliance to be controlled and a content of the control, and then the message generating section 17 generates, with reference to the content of the decision made by the control section 14, a proposal message putting forward a proposal to control the electrical appliance. Specifically, the message generating section 17 generates, with reference to the sixth table, a proposal message corresponding to the state of the user. For example, see a case where the sixth table shown in FIG. 10 is used. In this case, when the control section 14 chooses “TURN ON AIR CONDITIONER” as content of the control, the message generating section 17 generates a proposal message “TURN ON AIR CONDITIONER?”. The message generating section 17 sends the proposal message thus generated to the control section 14, and the control section 14 causes the cleaning robot 4 to output the proposal message generated by the message generating section 17 (S24). Specifically, the control section 14 transmits, to the management server 3 via the communication section 11, an operation instruction to output the proposal message generated by the message generating section 17. In accordance with the operation instruction received from the control server 1, the management server 3 causes the cleaning robot 4 to output the proposal message.

After that, input by the user is done (S25). Specifically, the user inputs a reply to the proposal message outputted by the cleaning robot 4. Then, the input information obtaining section 12 obtains, from the management server 3 via the communication section 11, the input information that the user inputted to the cleaning robot 4.

The response decision section 18 analyzes the input information obtained by the input information obtaining section 12 (S26), and determines the response to be made. Specifically, the response decision section 18 derives, with reference to the seventh table, a response corresponding to the reply that the user inputted to the cleaning robot 4. For example, see a case where the fifth table shown in FIG. 8 is used. In this case, when a word “yeah” is contained in an utterance produced by the user, the response decision section 18 decides, as the response to be made, to “EXECUTE CONTROL CORRESPONDING TO PROPOSAL”.

In a case where the user's reply is a reply that agrees to the proposal, the response decision section 18 decides to execute control corresponding to the proposal. When the response decision section 18 decides to execute control corresponding to the proposal, the control section 14 executes control based on the content of its decision (S27).

Thus described is a series of actions that are done to control an electrical appliance in the electrical appliance control system 100. In this way, the control server 1 decides, with reference to a result of a determination made by the determining section 13, an electrical appliance to be controlled and a content of the control, and then causes the cleaning robot 4 to output a proposal message putting forward a proposal to control the electrical appliance. This makes it possible, in a case where the user's reply is a reply that agrees to the proposal, to control the electrical appliance with reference to the content of the decision. In this case, the electrical appliance is controlled only in accordance with a proposal to which the user agreed. This circumvents the need to execute electrical appliance control that the user finds to be unnecessary.

(Example 3 of Electrical Appliance Control)

Here is a third specific example of a method in which the electrical appliance control system 100 controls an electrical appliance. The example below is merely an example, and the electrical appliance control system 100 according to the present embodiment is not to be limited solely to the example below.

Control of an electrical appliance by the electrical appliance control system 100 in a case where the user is feeling sick is described. It should be noted that it is assumed that the cleaning robot 4 includes an input/output function of receiving voice input and producing sound output.

When the user says “feeling sick”, the sound “feeling sick” made by the user is inputted to the cleaning robot 4. The cleaning robot 4 sends to the management server 3 the sound data thus inputted. The input information obtaining section 12 obtains, from the management server 3 via the communication section 11, the input information that the user inputted to the cleaning robot 4. The determining section 13 derives, with reference to the first table, a result of determination corresponding to the user's input to the cleaning robot 4. For example, see a case where the first table shown in FIG. 3 is used. In this case, when the words “feeling sick” are contained in an utterance produced by the user, the determining section 13 determines that the user is currently in such a state that he/she is “feeling sick”. The determining section 13 sends a result of the determination to the control section 14.

With reference to the second table, the control section 14 decides, in consideration of the state of the user, an electrical appliance to be controlled and a content of the control. For example, see a case where the second table shown in FIG. 4 is used. In this case, since the determining section 13 has determined that the user is currently in such a state that he/she is “feeling sick”, the control section 14 chooses the “TELEPHONE” as electrical appliance to be controlled and chooses “MAKE PHONE CALL” as content of the control.

The message generating section 17 generates, with reference to the sixth table, a proposal message corresponding to the state of the user. For example, see a case where the sixth table shown in FIG. 10 is used. In this case, since the control section 14 has chosen “MAKE PHONE CALL” as content of the control, the message generating section 17 generates a proposal message “MAKE PHONE CALL?”. The message generating section 17 sends the proposal message thus generated to the control section 14, and the control section 14 causes the cleaning robot 4 to output the proposal message generated by the message generating section 17.

After that, when the user says “yeah”, the sound “yeah” made by the user is inputted to the cleaning robot 4. The cleaning robot 4 sends to the management server 3 the sound data thus inputted. The input information obtaining section obtains, from the management server 3 via the communication section 11, the input information that the user inputted to the cleaning robot 4. The response decision section 18 derives, with reference to the seventh table, a response corresponding to the reply that the user inputted to the cleaning robot 4. For example, see a case where the seventh table shown in FIG. 11 is used. In this case, since the word “yeah” is contained in the utterance produced by the user, the response decision section 18 decides, as the response to be made, to “EXECUTE CONTROL CORRESPONDING TO PROPOSAL”. Since the response decision section 18 has decided to execute control corresponding to the proposal, the control section 14 refers to the content of its decision and transmits, to the management server 3 via the communication section 11, an instruction to make a phone call. In accordance with the operation instruction received from the control server 1, the management server 3 controls the telephone to make a phone call. It should be noted here that the person to whom a phone call is made here needs only be set in advance (e.g., relative, attending doctor).

It should be noted that instead of the management server 3 controlling a home telephone to make an outside phone call, the cleaning robot 4 may be provided with a function as an IP telephone so that the management server 3 can make an outside phone call via the cleaning robot 4 serving as an IP telephone based on VoIP (Voice over Internet Protocol) or the like. This allows the user to talk with the person as if the user were talking to the cleaning robot 4.

Further, it is needless to say that a combination of the second and third embodiments, too, is encompassed in the present invention, for example, such that the external information obtaining section 15 obtains, as external information, information on the user's movements, information from an activity meter (pedometer), a sphygmomanometer, a clinical thermometer, etc., and the like, and in a case where the user is making a predetermined movement (such as lying or coughing) or in a case where a value shown on the activity meter is less than a predetermined value or a value shown on the sphygmomanometer or the clinical thermometer is not less than a predetermined value, the estimating section 16 estimates that the user is currently in a “state that he/she is feeling sick”, and that the cleaning robot 4 outputs a question message “FEELING SICK?”, and in a case where the user makes a reply such as “yes” or “yeah” meaning affirmation, the cleaning robot 4 outputs a proposal message “MAKE PHONE CALL?”.

Examples of scenes where a phone call is made are not limited to a situation where the user is feeling sick, but include a scene where the user is having trouble with a failure in a machine and makes a phone call to a support center for the machine, a scene where the user makes a phone call to see how his/her grandchild is doing, and a scene where the user makes a phone call to a delivery agent to order in.

### Fourth Embodiment

The foregoing has taken, as the content of control over electrical appliances such as an air conditioner and an electric fan, an example of control with a choice between turning on or off such electrical appliances. However, this does not necessarily imply any limitation. For example, the content of control may be decided in accordance with the operating states of these electrical appliances. The term “operating state” here means a drive status indicating whether or not the power is on, a setting status such as a currently set temperature or set air volume (in a case where the power is on), and the like. In this case, the control server needs only further include an operation information obtaining section (not illustrated) that obtains information on the operating state of an electrical appliance. The control section 14 of the control server 1 decides the content of control with reference to information from the operation information obtaining section. Specifically, let it be assumed that the determining section 13 has determined that the user is in such a state that he/she is feeling hot. Then, in a case where the operation information obtaining section obtains information “the air conditioner is on with its temperature set at 28° C.” regarding the air conditioner, the control section 14 decides the content of control to be “lower the temperature of the air conditioner by 2° C.”, “set the temperature of the air conditioner at a temperature 2° C. lower than the current room temperature”, “set the temperature of the air conditioner at a temperature 3° C. lower than the current outside air temperature”, etc. Alternatively, in a case where the operation information obtaining section obtains information “the electric fan is on with its air volume set to ‘low’” regarding the electric fan, the control section 14 decides the content of control to be “set the air volume of the electric fan to ‘medium-’”, “set the air volume of the electric fan to ‘high’”, etc. Thus, the second table stored in the control section 14 may show correspondence between an electrical appliance to be controlled and a content of control corresponding to the operating state of the electrical appliance.

### Fifth Embodiment

The control server 1 of the electrical appliance control system 100 may be realized by a logic circuit (hardware) provided in an integrated circuit (IC chip) or the like or may be realized by software as executed by a CPU (Central Processing Unit).

In the latter case, the control server 1 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network or a broadcast wave) which enables transmission of the program. Note that the present invention can also be implemented by the program in the form of a computer data signal embedded in a carrier wave which is embodied by electronic transmission.

The foregoing has provided specific examples of items that are associated in the first to seventh tables. However, this does not necessarily imply any limitation. An administrator of the electrical appliance control system 100 needs only decide what items to be associated in the first to seventh tables.

Further, in the foregoing, the management server 3 controls an electrical appliance in accordance with an operation instruction received from the control server 1. However, this does not necessarily imply any limitation. For example, in accordance with an operation instruction received from the control server 1, the management server 3 may control an electrical appliance by causing a control signal to be transmitted from the cleaning robot 4 to the electrical appliance. An example of a method for transmitting a control signal from the cleaning robot 4 to an electrical appliance is a method in which the cleaning robot 4 functions as a remote controller to transmit such a control signal via infrared rays. Another example is a method in which the control server 1 controls an electrical appliance by transmitting a control signal directly to the electrical appliance. Examples of a method in which the control server 1 transmits a control signal to an electrical appliance is a method of transmission based on a wireless technology (such as Zigbee (registered trademark) or Z-Wave), an Internet appliance technology (technology for connecting domestic electrical appliances over a network), etc. as well as infrared transmission.

The present invention is not limited to the description of the embodiments above, but may be altered by a skilled person within the scope of the claims. An embodiment based on a proper combination of technical means disclosed in different embodiments is encompassed in the technical scope of the present invention.

In the examples described above, the cleaning robot 4 is used as an input/output device. However, the present invention is not necessarily to be limited to these examples. For example, a television or a smartphone may be used as an input/output device, a robot having an input/output function may be provided, or a microphone may be provided as an input device and a speaker as an output device. In a case where a television or a smartphone is used as an input/output device, it is possible to output text or pictures through the display screen of the television or the smartphone or to output sounds from the speaker of the television or the smartphone. For example, it is possible to display a virtual character on screen images that the television or the smartphone displays or to, in outputting a question message or a proposal message from the television or the smartphone, cause the character to appear as if it were speaking the message. Alternatively, in a case where a microphone is provided as an input device and a speaker as an output device, it is possible to cause the home per se to appear as if it were speaking a question message or a proposal message. Thus, there are various possible methods for input and output in the electrical appliance control system 1. Furthermore, the aforementioned cleaning robot 4 may be used as an input device.

Further, as mentioned above, examples of the input information that the input information obtaining section 12 obtains include text data, video data, etc. that are obtained by a user's inputting text or making motions (gestures), as well as sound data that is obtained by the user's making sounds. For example, it is possible to use input information that is obtained by the user's inputting how he/she is feeling (such as “hot” or “sleepy”) directly to the cleaning robot 4 or by the user's inputting his/her feeling to another input device that transmits the input to the cleaning robot 4. Alternatively, it is possible to use input information that is obtained by the cleaning robot 4 taking with a camera an image of the user's making a gesture of his/her feeling or the user's showing a card indicative of his/her feeling.

[Input Device]

The output function is not essential to the aforementioned cleaning robot 4 or the input/output device of a television or a smartphone. For this reason, the aforementioned input/output device is sometimes referred to simply as “input device”. The functions that the cleaning robot 4 has as an input device are as described above. The following more specifically describes components of such an input device.

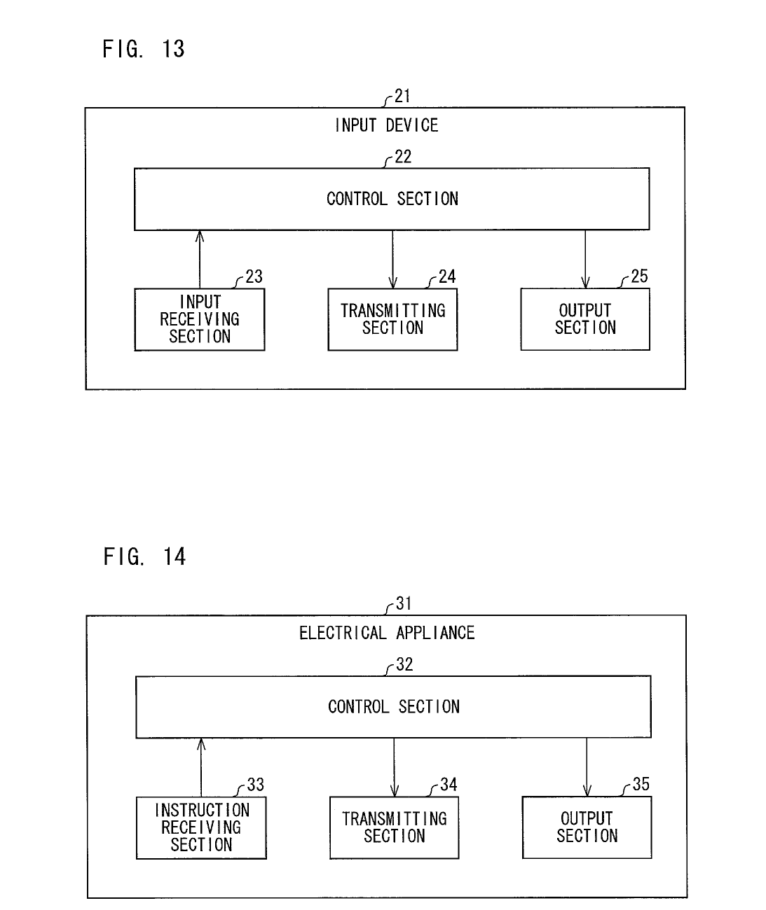

An input device according to an embodiment of the present invention for example includes the following components. FIG. 13 is a block diagram showing a configuration of a main part of an input device 21 according to an embodiment of the present invention.

The input device 21 includes a control section 22, an input receiving section 23 (input receiving means), a transmitting section 24 (transmitting means), and an output section 25. The control section 22 executes various types of control such as control of each component and control of the input device per se.

The input receiving section 23 receive input from a user. Further, the transmitting section 24 transmits, to the control server 1 (electrical appliance control apparatus), input information which indicates the input received by the input receiving section 23 and which is referred to for determining a state of the user and for deciding, with reference to a result of the determination of the state of the user, an electrical appliance to be controlled and a content of the control.

The output section 25 sends out to the user a question message asking the user about the state of the user, the question message being generated with reference to a result of an estimation of the state of the user as estimated with reference to external information. It should be noted here that the message is sent out by displaying the message or by outputting the message in the form of sounds from a speaker. Furthermore, the input receiving section 23 receives a reply that the user inputted in response to the question message, and the transmitting section 24 transmits information which indicates the reply as the input information to the control server 1.

Further, the output section 25 sends out to the user a proposal message putting forward a proposal to control the electrical appliance to be controlled, the proposal message being generated with reference to the electrical appliance to be controlled and the content of the control. Furthermore, the input receiving section 23 receives a reply that the user inputted in response to the proposal message, and the transmitting section 24 transmits, to the control server 1, information which indicates the reply as the input information and which, in a case where the reply is a reply that agrees to the proposal, is referred to for controlling, with reference to the electrical appliance to be controlled and the content of the control as decided, the electrical appliance to be controlled.

[Electrical Appliance]

The functions that an electrical appliance has are as described above. The following more specifically describes components of such an electrical appliance. FIG. 14 is a block diagram showing a configuration of a main part of an electrical appliance 31 according to an embodiment of the present invention.

The electrical appliance 31 has a control section 32, an instruction receiving section 33 (instruction receiving means), a transmitting section 34 (transmitting means), and an output section 35. The control section 32 executes various types of control such as control of each component and control of the electrical appliance 31 per se.

The instruction receiving section 33 receives an operation instruction referring to a content of control of an electrical appliance as decided by the control server 1 (electrical appliance control apparatus) analyzing a user's input to the input device, determining a state of the user, and referring to a result of the determination of the state of the user. The control section 32 controls the operation of the electrical appliance 31 per se in accordance with the operation instruction received by the instruction receiving section 33.

The output section 35 outputs external information in accordance with the operation instruction received by the instruction receiving section 33. It should be noted here that the external information is outputted by displaying the external information or by outputting the external information in the form of sounds from a speaker. The transmitting section 34 transmits operation information of the electrical appliance 31 per se to the control server 1. Furthermore, the instruction receiving section 33 receives the operation instruction referring to the content of the control of the electrical appliance 31 as decided by the control server 1 with reference to the operation information.

[Recapitulation]

An electrical appliance control apparatus (control server 1) according to a first aspect of the present invention includes: determining means (determining section 13, control section 14) for analyzing a user's input to an input device (cleaning robot 4), and for determining a state of the user; deciding means (control section 14) for deciding, with reference to a result of the determination made by the determining means, an electrical appliance to be controlled and a content of the control; and control means (control section 14) for controlling, with reference to a content of the decision made by the deciding means, the electrical appliance to be controlled.

Further, an electrical appliance control method according to a second aspect of the present invention includes: a determining step of analyzing a user's input to an input device, and of determining a state of the user; a deciding step of deciding, with reference to a result of the determination made in the determining step, an electrical appliance to be controlled and a content of the control; and a control step of controlling, with reference to a content of the decision made in the deciding step, the electrical appliance to be controlled.

According to the foregoing configuration, since information produced by the user's saying how he/she is feeling (such as “hot” or “sleepy”) is inputted to the input device, the determining means analyzes the information inputted to the input device and determines the state of the user. Then, with reference to a result of the determination, the control means controls the electrical appliance. Therefore, in an electrical appliance control apparatus according to an aspect of the present invention, the control means voluntarily controls an electrical appliance in consideration of the state of the user even without the user's voluntarily inputting an operation instruction to control the electrical appliance.

Some users hesitate to input operation instructions by themselves to operate electrical appliances, and other users just do not bother to do so. Further, for those users who are handicapped, it may be difficult to input operation instructions to operate domestic electrical appliances. However, the electrical appliance control apparatuses according to the first to third aspects of the present invention make it only necessary for a user to, for example, say how he/she is feeling, and makes it unnecessary for the user to input an operation instruction by him/herself to operate each electrical appliance. This makes it possible, without forcing the user to perform a complex operation, to control an electrical appliance. Therefore, the electrical appliance control apparatuses according to the first to third aspects of the present invention are most suitable to such users as those mentioned above.

For example, when the user says “hot”, the sound “hot” produced by the user is inputted to the input device. The determining means analyzes the user's input (i.e., the sound “hot”) to the input device, and determines the state of the user. In this case, the determining means determines that the user is in such a state that he/she is “feeling hot”. Since the determining means has determined that the user is in such a state that he/she is “feeling hot”, the deciding means decides, in accordance with the state, an electrical appliance to be controlled and a content of the control. For example, when the deciding means chooses “AIR CONDITIONER” as electrical appliance to be controlled and chooses “TURN ON AIR CONDITIONER” as content of the control, the control means turns on the air conditioner with reference to a content of the decision made by the deciding means.

Further, the electrical appliance control apparatus according to the third aspect of the present invention may be configured to further include: external information obtaining means (external information obtaining section 15) for obtaining external information; and estimating means (estimating section 16) for estimating the state of the user with reference to the external information, wherein: with reference to a result of the estimation made by the estimating means, the determining means causes an output section of the input device to send out to the user a question message asking the user about the state of the user; and the determining means analyzes a reply that the user inputted to the input device in response to the question message and determines the state of the user.

According to the foregoing configuration, the estimating means estimates the state of the user with reference to external information. Then, with reference to a result of the estimation, the control means causes the input device to output a question message asking the user about his/her state. This makes it possible to, before the user tells how he/she is feeling (such as “hot” or “sleepy”), estimate the state of the user and cause the input/output device to ask the user about his/her state. Such a question from the input device encourages the user to tell the input device about his/her state with less hesitation. In particular, in order for the control means to voluntarily control an electrical appliance, the user needs only make a reply such as “yeah” or “yes” meaning affirmation to a question message outputted by the input device. This makes it unnecessary for the user to control the electrical appliance by him/herself, and is very simple for the user.

Further, the electrical appliance control apparatus according to a fourth aspect of the present invention may be configured such that: with reference to the content of the decision made by the deciding means, the control means causes an output section of the input device to send out to the user a proposal message putting forward a proposal to control the electrical appliance to be controlled; and in a case where a reply that the user inputted to the input device in response to the proposal message is a reply that agrees to the proposal, the control means executes, on the electrical appliance to be controlled, control based on the content of the decision made by the deciding means.

In this way, the control means decides, with reference to a result of a determination made by the determining means, an electrical appliance to be controlled and a content of the control, and then causes the input device to output a proposal message putting forward a proposal to control the electrical appliance. This makes it possible, in a case where the user's reply is a reply that agrees to the proposal, to control the electrical appliance with reference to the content of the decision. In this case, the electrical appliance is controlled only in accordance with a proposal to which the user agreed. This circumvents the need to execute electrical appliance control that the user finds to be unnecessary.

The electrical appliance control apparatus according to the foregoing embodiments of the present invention may be realized by a computer. In this case, the present invention encompasses: a program for the electrical appliance control apparatus which program causes a computer to operate as the foregoing means of the electrical appliance control apparatus so that the electrical appliance control apparatus can be realized by the computer; and a computer-readable storage medium storing the program therein.

Further, an electrical appliance control system according to a fifth aspect of the present invention may be an electrical appliance control system including: an input device for receiving input from a user; an electrical appliance control apparatus for controlling an electrical appliance; and the electrical appliance, which is to be controlled by the electrical appliance control apparatus, the electrical appliance control apparatus including: determining means for analyzing a user's input to an input device, and for determining a state of the user; deciding means for deciding, with reference to a result of the determination made by the determining means, an electrical appliance to be controlled and a content of the control; and control means for controlling, with reference to a content of the decision made by the deciding means, the electrical appliance to be controlled.

The foregoing configuration makes it possible to provide an electrical appliance control system that controls an electrical appliance in consideration of the state of a user without the user's voluntarily inputting an operation instruction to operate the electrical appliance.

Further, an input device according to a sixth aspect of the present invention may include: input receiving means for receiving input from a user; and transmitting means for transmitting, to an electrical appliance control apparatus, input information which indicates the input received by the input receiving means and which is referred to for determining a state of the user and for deciding, with reference to a result of the determination of the state of the user, an electrical appliance to be controlled and a content of the control.

The foregoing configuration makes it possible to provide an input device for controlling an electrical appliance in consideration of the state of a user without the user's voluntarily inputting an operation instruction to operate the electrical appliance.

Further, the input device according to a seventh aspect of the present invention may be configured to further include an output section for sending out to the user a question message asking the user about the state of the user, the question message being generated with reference to a result of an estimation of the state of the user as estimated with reference to external information, wherein: the input receiving means receives a reply that the user inputted in response to the question message; and the transmitting means transmits information which indicates the reply as the input information to the electrical appliance control apparatus.

The foregoing configuration makes it possible to output a question message asking the user about the state of the user, the question message being generated with reference to a result of an estimation of the state of the user as estimated with reference to external information.

Further, the input device according to an eighth aspect of the present invention may be configured to further include an output section for sending out to the user a proposal message putting forward a proposal to control the electrical appliance to be controlled, the proposal message being generated with reference to the electrical appliance to be controlled and the content of the control, wherein: the input receiving means receives a reply that the user inputted in response to the proposal message; and the transmitting means transmits, to the electrical appliance control apparatus, information which indicates the reply as the input information and which, in a case where the reply is a reply that agrees to the proposal, is referred to for controlling, with reference to the electrical appliance to be controlled and the content of the control as decided, the electrical appliance to be controlled.

The foregoing configuration makes it possible to, once an electrical appliance to be controlled and a content of the control have been decided, output a proposal message putting forward a proposal to control the electrical appliance.

Further, an electrical appliance according to a ninth aspect of the present invention may include: an instruction receiving means for receiving an operation instruction referring to a content of control of an electrical appliance as decided by an electrical appliance control apparatus analyzing a user's input to the input device, determining a state of the user, and referring to a result of the determination of the state of the user, the electrical appliance controlling its operation in accordance with the operation instruction received by the instruction receiving means.

The foregoing configuration makes it possible to provide an electrical appliance that is controlled in consideration of the state of a user without the user's voluntarily inputting an operation instruction to operate the electrical appliance.

Further, the electrical appliance according to a tenth aspect of the present invention may be configured to further include an output section for outputting external information in accordance with the operation instruction received by the instruction receiving means.

The foregoing configuration makes it possible to, with reference to the content of the control thus decided, cause the electrical appliance to output external information.

Further, the electrical appliance according to a tenth aspect of the present invention may be configured to further include transmitting means for transmitting operation information of the electrical appliance to the electrical appliance control apparatus, wherein the instruction receiving means receives the operation instruction referring to the content of the control of the electrical appliance as decided by the electrical appliance control apparatus with reference to the operation information.

The foregoing configuration makes it possible to control the electrical appliance with reference to the content of control as decided in accordance with an operating state of the electrical appliance.

### INDUSTRIAL APPLICABILITY

The present invention is suitably applicable as an electrical appliance control apparatus, an electrical appliance control system, a program, and an electrical appliance control method for controlling an electrical appliance.

### REFERENCE SIGNS LIST

1 Control server
2 External information server
3 Management server
4 Cleaning robot
11 Communication section
12 Input information obtaining section
13 Determining section (determining means)
14 Control section (determining means, deciding means, control means)
15 External information obtaining section (external information obtaining means)
16 Estimating section (estimating means)
17 Message generating section
18 Response decision section
100 Electrical appliance control system

1. An electrical appliance control apparatus comprising:
determining means for analyzing a user's input to an input device, and for determining a state of the user;
deciding means for deciding, with reference to a result of the determination made by the determining means, an electrical appliance to be controlled and a content of the control; and
control means for controlling, with reference to a content of the decision made by the deciding means, the electrical appliance to be controlled.

2. The electrical appliance control apparatus as set forth in claim 1, further comprising:
external information obtaining means for obtaining external information; and
estimating means for estimating the state of the user with reference to the external information, wherein:
with reference to a result of the estimation made by the estimating means, the determining means causes an output section of the input device to send out to the user a question message asking the user about the state of the user; and
the determining means analyzes a reply that the user inputted to the input device in response to the question message and determines the state of the user.

3. The electrical appliance control apparatus as set forth in claim 1, wherein:
with reference to the content of the decision made by the deciding means, the control means causes an output section of the input device to send out to the user a proposal message putting forward a proposal to control the electrical appliance to be controlled; and
in a case where a reply that the user inputted to the input device in response to the proposal message is a reply that agrees to the proposal, the control means executes, on the electrical appliance to be controlled, control based on the content of the decision made by the deciding means.

4. An electrical appliance control method comprising:
a determining step of analyzing a user's input to an input device, and of determining a state of the user;
a deciding step of deciding, with reference to a result of the determination made in the determining step, an electrical appliance to be controlled and a content of the control; and
a control step of controlling, with reference to a content of the decision made in the deciding step, the electrical appliance to be controlled.

5. An electrical appliance control system including:
an input device for receiving input from a user;
an electrical appliance control apparatus for controlling an electrical appliance; and
the electrical appliance, which is to be controlled by the electrical appliance control apparatus,
the electrical appliance control apparatus comprising:
determining means for analyzing a user's input to an input device, and for determining a state of the user;
deciding means for deciding, with reference to a result of the determination made by the determining means, an electrical appliance to be controlled and a content of the control; and
control means for controlling, with reference to a content of the decision made by the deciding means, the electrical appliance to be controlled.

6. An input device comprising:
input receiving means for receiving input from a user; and
transmitting means for transmitting, to an electrical appliance control apparatus, input information which indicates the input received by the input receiving means and which is referred to for determining a state of the user and for deciding, with reference to a result of the determination of the state of the user, an electrical appliance to be controlled and a content of the control.

7. The input device as set forth in claim 6, further comprising an output section for sending out to the user a question message asking the user about the state of the user, the question message being generated with reference to a result of an estimation of the state of the user as estimated with reference to external information, wherein:
the input receiving means receives a reply that the user inputted in response to the question message; and
the transmitting means transmits information which indicates the reply as the input information to the electrical appliance control apparatus.

8. The input device as set forth in claim 6, further comprising an output section for sending out to the user a proposal message putting forward a proposal to control the electrical appliance to be controlled, the proposal message being generated with reference to the electrical appliance to be controlled and the content of the control, wherein:
the input receiving means receives a reply that the user inputted in response to the proposal message; and
the transmitting means transmits, to the electrical appliance control apparatus, information which indicates the reply as the input information and which, in a case where the reply is a reply that agrees to the proposal, is referred to for controlling, with reference to the electrical appliance to be controlled and the content of the control as decided, the electrical appliance to be controlled.

9. An electrical appliance comprising:
an instruction receiving means for receiving an operation instruction referring to a content of control of an electrical appliance as decided by an electrical appliance control apparatus analyzing a user's input to the input device, determining a state of the user, and referring to a result of the determination of the state of the user,
the electrical appliance controlling its operation in accordance with the operation instruction received by the instruction receiving means.

10. The electrical appliance as set forth in claim 9, further comprising an output section for outputting external information in accordance with the operation instruction received by the instruction receiving means.

11. The electrical appliance as set forth in claim 9, further comprising transmitting means for transmitting operation information of the electrical appliance to the electrical appliance control apparatus, wherein
the instruction receiving means receives the operation instruction referring to the content of the control of the electrical appliance as decided by the electrical appliance control apparatus with reference to the operation information.
